(19) United States
(12) Patent Application Publication
(10) Pub. No.: US 2012/0149520 A1
(43) Pub. Date: Jun. 14, 2012

(54) Hydraulic Free Multispeed Transmissions for Electric Vehicles and Fuel Cell Hybrid Vehicles and Systems for Shifting the Same

(75) Inventors: Brian Carl Schneidewind, Ann Arbor, MI (US); John Patrick Reedy, Salt Lake City, UT (US)

(73) Assignee: Toyota Motor Engineering & Manufacturing North America, Inc., Erlanger, KY (US)

(21) Appl. No.: 12/966,222

(22) Filed: Dec. 13, 2010

(51) Int. Cl. F16H 3/44

(52) U.S. Cl. 475/149; 475/296; 475/297; 180/65.22

(57) ABSTRACT

A multispeed transmission includes a sun gear, at least one high-speed planetary gear in constant mesh with the sun gear and a high-speed ring gear, where the high-speed planetary gear orbits around the sun gear. The multispeed transmission also includes at least one low-speed planetary gear coupled with the high-speed planetary gear and in constant mesh with a low-speed ring gear and a carrier rotationally engaged with the high-speed planetary gear and the low-speed planetary gear such that either the high-speed planetary gear or the low-speed planetary gear controls rotation of the carrier. The multispeed transmission further includes a transmission case that surrounds the high-speed ring gear and the low-speed ring gear and a clutch located proximate to the high-speed ring gear and the low-speed ring gear, where the clutch selectively couples the high-speed ring gear or the low-speed ring gear with the transmission case.

### TECHNICAL FIELD

The present specification generally relates to transmissions for vehicles and, more specifically, to hydraulic-free multispeed transmissions.

### BACKGROUND

In motor vehicles driven by an electric motor, there is a desire to use multispeed transmissions in order to operate the electric motor at high efficiency. Operating the electric motor at high efficiency may provide a performance advantage in terms of weight, acceleration, or range of a vehicle.

Previous attempts to use multispeed transmissions in vehicles with electric motors involved using transmissions that shift gears using hydraulically-actuated clutch members. The use of a hydraulically-actuated clutch typically requires increasing the size of the transmission to accommodate the clutch features. Additionally, there are significant parasitic losses for the engine associated with hydraulic pumps required to actuate the clutch members. These parasitic losses typically result in reduced fuel economy for the vehicle.

Accordingly, a need exists for geartrain structures that enable hydraulic free multispeed transmissions for vehicles having electric motors and systems for shifting the same.

### SUMMARY

In one embodiment, a multispeed transmission includes a sun gear, at least one high-speed planetary gear in constant mesh with the sun gear and a high-speed ring gear, where the high-speed planetary gear orbits around the sun gear. The multispeed transmission also includes at least one low-speed planetary gear coupled with the high-speed planetary gear and in constant mesh with a low-speed ring gear and a carrier rotationally engaged with the high-speed planetary gear and the low-speed planetary gear such that either the high-speed planetary gear or the low-speed planetary gear controls rotation of the carrier. The multispeed transmission further includes a transmission case that surrounds the high-speed ring gear and the low-speed ring gear and a clutch located proximate to the high-speed ring gear and the low-speed ring gear, where the clutch selectively couples the high-speed ring gear or the low-speed ring gear with the transmission case.

In another embodiment, a powertrain system for an electrically-powered vehicle includes an electric motor and a multispeed transmission. The multispeed transmission includes a transmission case connected to the electric motor, a sun gear located in the transmission case and coupled with the electric motor, a high-speed gear set in constant mesh with the sun gear, a low-speed gear set connected to the high-speed gear set, and a clutch arranged and configured to selectively change operating modes of the multispeed transmission from one operating mode to a different operating mode. The operating modes may include a high-speed mode, a low-speed mode and a neutral state. The clutch engages the low-speed gear set with the transmission case to place the multispeed transmission in the low-speed mode.

In another embodiment, a powertrain system for an electrically-powered vehicle having a multispeed transmission includes an electric motor, a transmission case connected to the electric motor, and a suit gear located in the transmission case and coupled with the electric motor. The powertrain system further includes a high-speed gear set in constant mesh with the sun gear, a low-speed gear set connected to the high-speed gear set, and a clutch arranged and configured to selectively couple the high-speed gear set and the low-speed gear set to the transmission case for changing control of a carrier operatively connected to an output shaft of the vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a schematic representation of a powertrain system for a vehicle according to one or more embodiments shown and described herein;

FIG. 2 depicts a schematic representation of a powertrain system for a vehicle according to one or more embodiments shown and described herein;

FIG. 3 depicts a schematic representation of a speed diagram of a transmission according to one or more embodiments shown and described herein;

FIG. 4 depicts a schematic representation of a motor efficiency map according to one or more embodiments shown and described herein;

FIG. 5 depicts a schematic representation of a powertrain system for a vehicle according to one or more embodiments shown and described herein;

FIG. 6 depicts a schematic representation of a powertrain system with an electromagnetic dog clutch for a vehicle according to one or more embodiments shown and described herein;

FIG. 7 depicts a schematic representation of a clutch according to one or more embodiments shown and described herein;

FIG. 8 depicts a schematic representation of a powertrain system with a ball ramp dog clutch for a vehicle according to one or more embodiments shown and described herein;

FIG. 9 depicts a schematic representation of a clutch according to one or more embodiments shown and described herein; and

FIG. 10 depicts a schematic representation of a powertrain system with a selectable one way clutch for a vehicle according to one or more embodiments shown and described herein.

### DETAILED DESCRIPTION

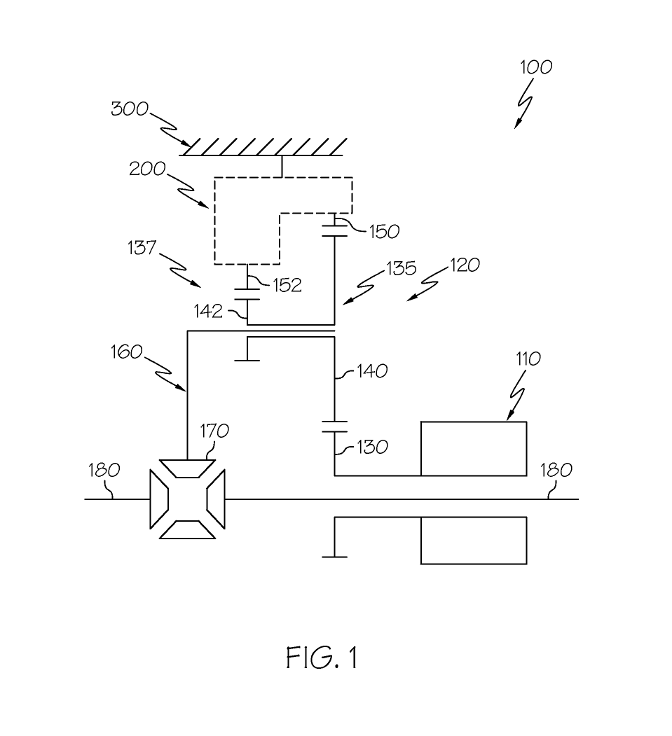

FIG. 1 generally depicts one embodiment of a system for shifting a multispeed transmission of an electrically powered vehicle, such as a an electric vehicle or a fuel cell hybrid vehicle. The system generally includes an electric motor and a set of high-speed and low-speed planetary gears in constant mesh with the motor. The planetary gears are mounted on a carrier that is coupled to a differential that provides torque to the wheels of the vehicle through a set of output shafts. A high-speed and a low-speed ring gear are arranged in constant mesh with the high-speed and low-speed planetary gears, respectively. A clutch is arranged between the ring gears and the transmission case. As used herein, clutch means a mechanical device that couples two features to prevent them from rotating relative to one another by interference, not by friction. Examples of clutches include, but are not limited to, interlocking spline dog clutch, mechanical synchronizers, and selectable one way clutches (SOWC). As used herein, a clutch does not include a device that uses friction plates to couple two features that rotate relative to one another.

When operating in a selected speed mode, the clutch engages a ring gear to the transmission case, holding the ring gear with zero rotational velocity. When a shift is ordered, the clutch decouples from the previously selected ring gear. The electric motor then accelerates or decelerates such that the rotational velocity of the newly selected ring gear approaches zero. As the newly selected ring gear approaches zero velocity, the clutch engages the newly selected ring gear and couples it with the transmission case, thus operating the multispeed transmission in a second speed mode. As used herein, engaged means coupling at least one member of the stated gear set with the transmission case such that the gear set is mechanically prevented from rotating, such that the multispeed transmission operates in a particular operating mode associated with the engaged gear set. By using the electric motor to slow the rotational velocity of the appropriate ring gear, the transmission may be able to shift gears smoothly without using a friction clutch. Various embodiments of systems and methods for shifting multispeed transmissions for electric vehicles and fuel cell hybrid vehicles will be described in more detail herein with reference to the appended figures.

Referring to FIG. 1, one embodiment of a powertrain system 100 for use with an electric vehicle or a fuel cell hybrid vehicle is schematically depicted. The powertrain system 100 generally comprises an electric motor 110 and a multispeed transmission 120. The electric motor 110 is coupled with a sun gear 130 of the multispeed transmission 120. The sun gear 130 is in constant mesh with a high-speed gear set 135 including at least one high-speed planetary gear 140. The high-speed planetary gear 140 is coupled with a low-speed gear set 137 including at least one low-speed planetary gear 142. The high-speed planetary gear 140 and the low-speed planetary gear 142 rotate at the same velocity. In the embodiment of FIG. 1, the high-speed planetary gear 140 and the low-speed planetary gear 142 are both part of the same pinion gear component. In this embodiment, the high-speed planetary gear 140 and the low-speed planetary gear 142 are mounted on a carrier 160 and orbit around the sun gear 130. The carrier 160 is connected to a differential 170 that provides torque to at least one output shaft 180. The high-speed planetary gear 140 is in constant mesh with a high-speed ring gear 150 that is part of the high-speed gear set 135. The low-speed planetary gear 142 is in constant mesh with the low-speed ring gear 152 that is part of the low-speed gear set 137.

A cutch 200 may be located proximate to the transmission case 300, such that the clutch 200 can selectively engage either the high-speed ring gear 150 or the low-speed ring gear 152 with the transmission case 300. In steady-state operation, when one of the high-speed or the low-speed ring gears 150, 152 is engaged with the transmission case 300, the other of the high-speed or low-speed ring gears 150, 152 rotates without constraint. For example, when the clutch 200 engages the high-speed ring gear 150 with the transmission case 300, the low-speed ring gear 152 rotates about the low-speed planetary gear 142 without constraint. When the cutch 200 engages the low-speed ring gear 152 with the transmission case 300, the high-speed ring gear 150 rotates about the high-speed planetary gear 140 without constraint.

Because the high-speed and low-speed planetary gears 140, 142 are coupled together and are mounted to the carrier 160, the high-speed and low-speed planetary gears 140, 142 orbit the sun gear 130 at approximately the same rate as the output shafts 180 rotate. The rotational velocity of the output shafts 180 correlate to the velocity of the vehicle. At a constant vehicle velocity, the carrier 160 and the high-speed and low-speed planetary gears 140, 142 may rotate at a constant rotational velocity.

If the multispeed transmission 120 is operating in a low-speed mode, the clutch 200 couples the low-speed ring gear 152 to the transmission case 300 such that the low-speed gear set 137 controls carrier 160 rotation. An upshift may be ordered to change the multispeed transmission 120 from operating in a low-speed mode to a high-speed mode. The clutch 200 disengages from the low-speed ring gear 152 such that the low-speed ring gear 152 is no longer engaged with the transmission case 300. With neither the low-speed ring gear 152 nor the high-speed ring gear 150 engaged with the transmission case 300, the electric motor 110 does not provide torque to the carrier 160 and the output shaft 180, and the powertrain system 100 is in a “neutral” state, or an operating condition where the electric motor 110 cannot transfer torque to the output shafts 180. While in this neutral state, the electric motor 110 may be controlled to slow the high-speed ring gear 150 such that the rotational velocity of the high-speed ring gear 150 approaches zero. The electric motor 110 slows the rotational velocity of the high-speed ring gear 150 by decreasing the rotational velocity of the electric motor 110 and the sun gear 130. Once the high-speed ring gear 150 has been slowed to an appropriate velocity, the clutch 200 may engage the high-speed ring gear 150 and couple the high-speed ring gear 150 with the transmission case 300 such that the high-speed gear set 135 controls carrier 160 rotation, thereby operating the transmission in a high-speed mode.

If the multispeed transmission 120 is operating in a high-speed mode, the clutch 200 couples the high-speed ring gear 150 to the transmission case 300 such that the high-speed gear set 135 controls carrier 160 rotation. A downshift may be ordered to change the multispeed transmission 120 from operating in a high-speed mode to a low-speed mode. The clutch 200 disengages the high-speed ring gear 150 such that the high-speed ring gear 150 is no longer coupled with the transmission case 300. With neither the low-speed ring gear 152 nor the high-speed ring gear 150 engaged with the transmission case 300, the electric motor 110 does not provide a torque to the carrier 160 and the output shaft 180, and the powertrain system 100 is, again, in a neutral state. While in this neutral state, the electric motor 110 may be controlled to slow the low-speed ring gear 152 such that the rotational velocity of the low-speed ring gear 152 approaches zero. The electric motor 110 slows the rotational velocity of the low-speed ring gear 152 by increasing the rotational velocity of the electric motor 110 and the sun gear 130. Once the low-speed ring gear 152 has been slowed to an appropriate velocity, the clutch 200 may engage the low-speed ring gear 152 and couple the low-speed ring gear 152 with the transmission case 300 such that the low-speed gear set 137 controls carrier 160 rotation, thereby operating the transmission in a low-speed mode.

When the vehicle is in a neutral state, the electric motor 110 may be able to change the rotational velocity of both the high-speed ring gear 150 and the low-speed ring gear 152 because the high-speed and low-speed ring gears 150, 152 are in constant mesh with the high-speed and low-speed planetary gears 140, 142 and the sun gear 130. The carrier 160 causes the high-speed and low-speed planetary gears 140, 142 to orbit the sun gear 130 at a constant rate for a given output shaft 180 rotational velocity while the powertrain system 100 is in a neutral state. Thus, given a rotational velocity of the carrier 160, when the powertrain system 100 is in the neutral state, the electric motor 110 may control the rotational velocity of both the high-speed and low-speed ring gears 150, 152.

Being able to control the rotational velocities of the high-speed and low-speed ring gears 150, 152, allows for the selection of the low-speed mode to the high-speed mode of the multispeed transmission 120 without the use of a friction clutch. This may have significant advantages for overall vehicle efficiency, because friction clutches are typically operated with hydraulic pressure. In order to provide hydraulic pressure to the clutch actuator, the motor of the vehicle must provide power to a hydraulic pump to maintain a minimum level of hydraulic pressure. This power may represent a parasitic loss to the motor, which may result in decreased efficiency of the powertrain system 100. The driver may see this parasitic loss as increased energy usage. Use of a hydraulic system may be particularly problematic for electric vehicles and fuel cell hybrid vehicles because while stopped, the drive motors of such vehicles are typically stopped. In order to provide power to a hydraulic pump, a second electric motor may be added to the vehicle, increasing cost and complexity of the vehicle.

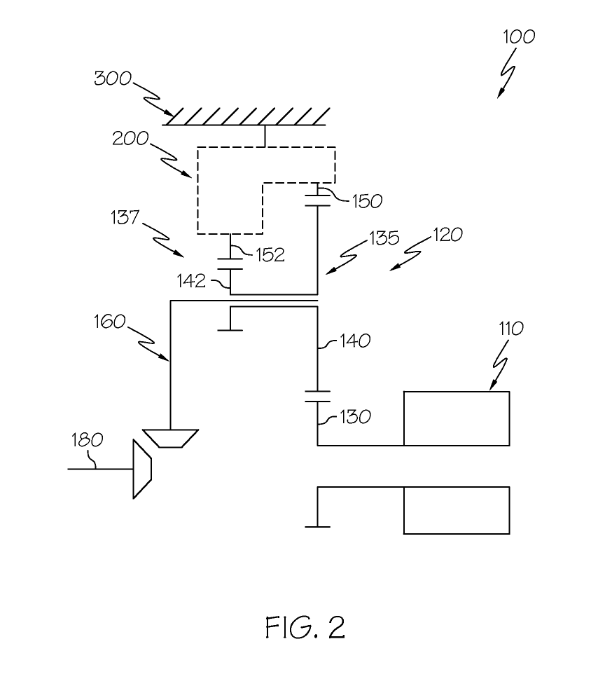

As is schematically depicted in FIG. 1, the powertrain system 100 may be integrated in a vehicle in a “Single Axis” arrangement. The electric motor 110 and the sun gear 130 may be arranged co-axially with the output shafts 180. This layout of the powertrain system 100 may be used, for example, in front-wheel drive vehicles, where the powertrain system 100 allows the electric motor 110 to be mounted along the output shafts 180. As is schematically depicted in FIG. 2, the powertrain system 100 may be configured such that the output shaft 180 directs torque to drive wheels at a location away from the electric motor 110. This layout of the powertrain system 100 may be used, for example, in rear-wheel drive vehicles.

The planetary gearing arrangements described above can be modified to suit a variety of applications and packaging limitations. In one embodiment of the multispeed transmission 120, the low-speed planetary gear 142 may be configured to mesh directly with the sun gear 130. In another embodiment, the multispeed transmission 120 may be arranged with a plurality of ring gears, such that the multispeed transmission 120 can have an equivalent number of operating speeds as ring gears.

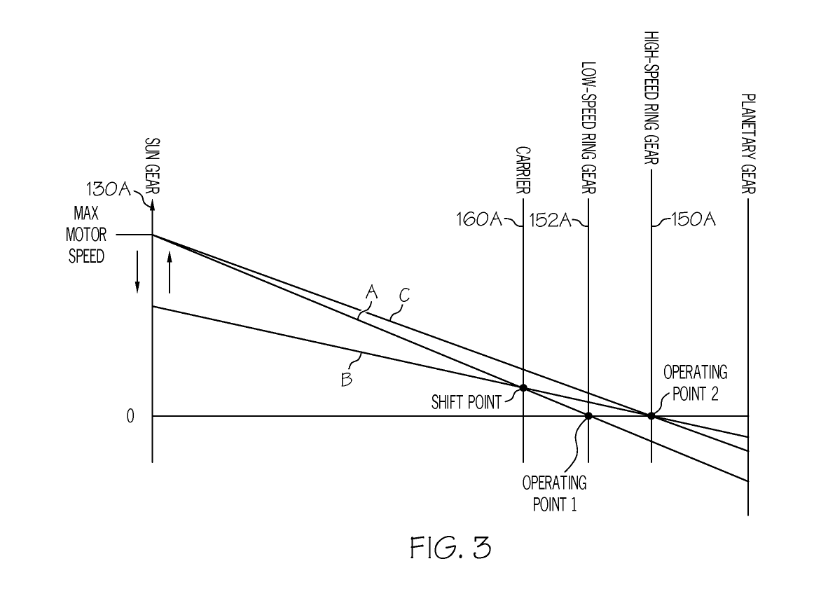

FIG. 3 depicts a schematic drawing of a speed diagram of one embodiment of the powertrain system 100 for a vehicle having a two-speed planetary gear set. The speed graph depicts graphically the operation of a powertrain system 100 at a variety of operating points. As drawn here, the vertical lines are drawn at a distance from the vertical line 130A that corresponds to the speed ratio of the planetary gear set. The intersection of the lines labeled “A,” “B,” and “C” with the vertical lines represents the rotational velocity of the components of the planetary gear set.

The speed diagram depicted in FIG. 3 can be used to illustrate how the internal components of the multispeed transmission 120 behave during steady-state operation. For example, in one embodiment of the multispeed transmission 120, the low-speed ring gear 152 may be prevented from rotating, such as being engaged with the transmission case 300. A speed line “A” may be drawn so that it passes through the intersection point of line 152A, representing the low-speed ring gear 152, and the zero velocity line, the horizontal line labeled 0. This point, labeled as “Operating Point 1” in FIG. 3, reflects that the low-speed ring gear 152 has zero rotational velocity. As the electric motor 110 rotational velocity increases, the speed line is drawn so that it increases in the positive y-direction along line 130A while still passing through Operating Point 1. The intersection points between this speed line and the vertical lines representing the other gears reflects the rotational velocity of these gears. In particular, the rotational velocity of the carrier 160, and therefore the differential 170 and the output shaft 180, is represented by the vertical line labeled 160A. This intersection point may be directly correlated to vehicle velocity, regardless of whether the multispeed transmission 120 is in a high-speed mode or a low-speed mode. As the electric motor 110 rotational velocity increases and the speed line continues to pass through Operating Point 1, the carrier 160 rotational velocity, and therefore the vehicle velocity, may increase at a fixed ratio.

The speed diagram can also be used to reflect how the internal components of the multispeed transmission 120 behave during a shift operation. One embodiment of a gear change is depicted in FIG. 3. Initially, the multispeed transmission 120 is being operated in a low-speed mode. In this embodiment, the low-speed ring gear 152 is prevented from rotating in the low-speed mode, and the speed line passes through Operating Point 1. With the electric motor 110 operating at maximum rotational velocity (Line A), a shift is ordered. The clutch 200 disengages the low-speed ring gear 152, which decouples the low-speed ring gear 152 from the transmission case 300, and the low-speed ring gear 152 is allowed to begin rotating, thus placing the powertrain system 100 in a neutral state. In the embodiment depicted in FIG. 3, it is assumed that the vehicle continues to travel at a constant velocity while the powertrain system 100 is in a neutral state. Because the vehicle continues to move at a constant inertia, the carrier 160, represented by line 160A, continues to rotate at a constant rotational velocity, as indicated by “Shift Point.” The electric motor 110 then decreases its rotational velocity. As the electric motor 110 decreases its rotational velocity, the speed line “pivots” through the Shift Point until such a point that the speed line passes through “Operating Point 2,” the intersection of the line 150A, representing the high-speed ring gear 150, and the zero velocity line (as shown with Line B). Once the rotational velocity of the high-speed ring gear 150 is approximately zero, the high-speed ring gear 150 can be engaged by the clutch 200, which couples the high-speed ring gear 150 with the transmission case 300, such that the high-speed ring gear 150 is prevented from rotating. The multispeed transmission 120 is now being operated in a high-speed mode. The electric motor 110 can increase its rotational velocity until it reaches its maximum motor rotational velocity (as shown with Line C). For a given rotational velocity of the electric motor 110, the rotational velocity of the carrier 160 may be greater when the transmission is operating in a high-speed mode than when the transmission is operating in a low-speed mode (i.e., compare the intersection of lines A and C with line 160A).

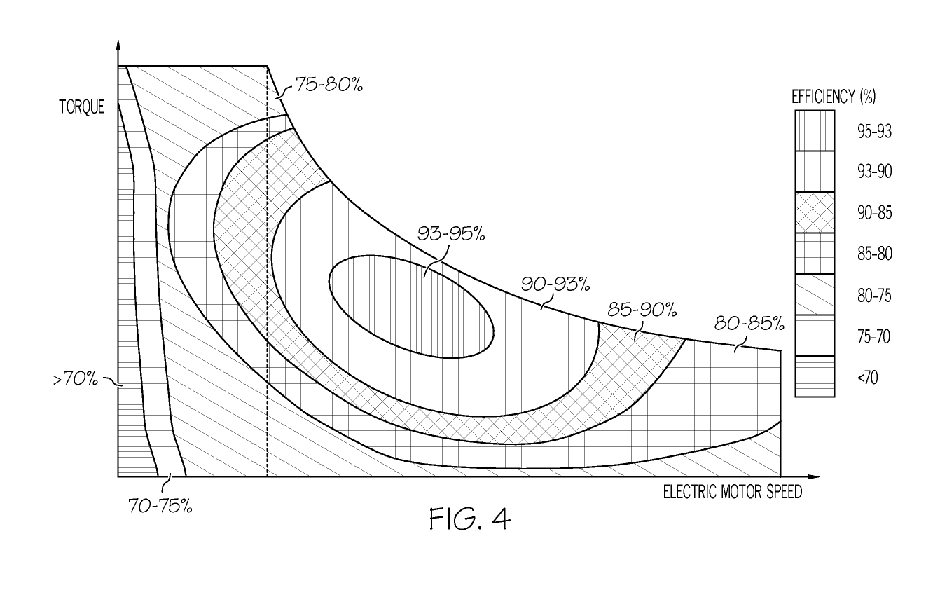

The use of a multispeed transmission 120 with an electric motor 110 may allow the electric motor 110 to be operated with greater efficiency than it could be with a single-speed transmission. As depicted by a sample motor efficiency map in FIG. 4, an electric motor 110 may be more efficient at certain operating conditions than at others. Being more efficient allows the electric motor 110 to output the same power (torque multiplied by speed) using less electrical energy. As described herein, providing a vehicle with a multispeed transmission 120 allows an electric motor 110 to operate at a lower rotational velocity and a higher torque than if the electric motor 110 was provided with a single speed transmission. In one embodiment, the increased efficiency of the powertrain system 100 may allow for the use of a smaller battery or smaller electric motor 110 with the same performance characteristics of the vehicle. In another embodiment, the increased efficiency of the powertrain system 100 may allow for increased acceleration performance and/or vehicle range of the vehicle using the same electric motor 110.

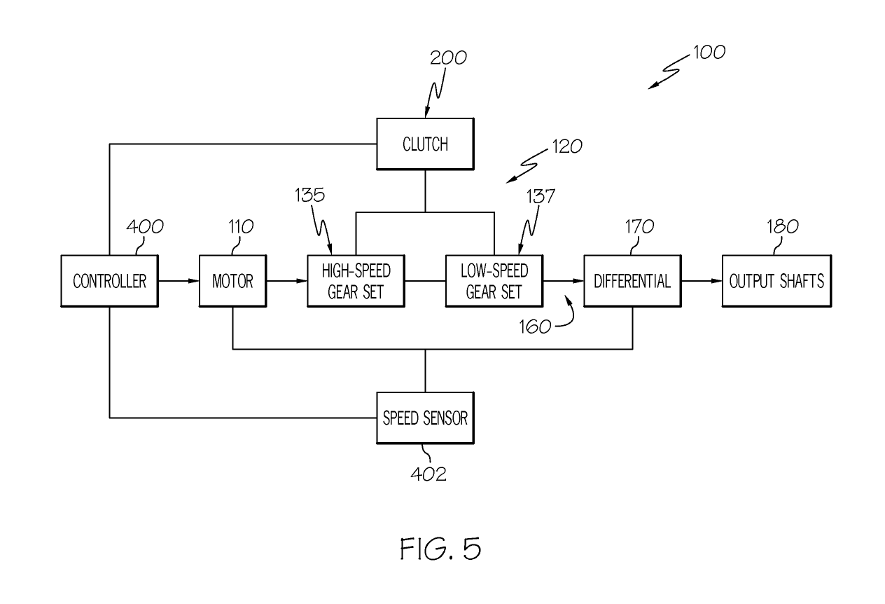

A schematic drawing of the powertrain system 100 is depicted in FIG. 5. The powertrain system 100 includes a controller 400 that has logic to control the electric motor 110 and the multispeed transmission 120 when a gear shift is ordered. The controller 400 provides commands to the electric motor 110 to change rotational velocity and commands to the multispeed transmission 120 to operate in a low-speed mode or a high-speed mode. If a gear shift is ordered, the controller 400 commands the clutch 200 to disengage the currently selected ring gear of the high-speed gear set 135 or the low-speed gear set 137 from the transmission case 300. With both the high-speed ring gear 150 and the low-speed ring gear 152 disengaged from the transmission case 300, the powertrain system 100 is in a neutral condition. The controller 400 commands the electric motor 110 to change its rotational velocity such that the rotational velocity of the newly-selecting ring gear of the high-speed gear set 135 or the low-speed gear set 137 approaches zero. The controller 400 is able to determine the rotational velocity of the newly-selected ring gear based on input from at least one speed sensor 402. When the controller 400 determines that the rotational velocity of the newly-selected ring gear is approaching zero, the controller 400 orders the clutch 200 to engage the newly-selected ring gear with the transmission case 300. Thus, the multispeed transmission 120 would be operating in a new speed mode.

In one embodiment, the controller 400 may allow for control of the electric motor 110 to improve shift performance of the multispeed transmission 120. The controller 400 may be able to control the rotational velocity of the electric motor 110 to reduce and minimize the occurrence of “shift shock” in the multispeed transmission 120, or a disruption of torque throughout the powertrain system 100. By being able to precisely determine the rotational velocity of the newly-selected ring gear, the controller 400 is able to hold the newly-selected ring gear at a rotational velocity approaching zero while the clutch 200 couples the newly-selected ring gear with the transmission case 300. By doing this, the clutch 200 is able to couple the newly-selected ring gear with the transmission case 300 without disrupting the torque flow through the powertrain system 100, and therefore reduce shift shock of the multispeed transmission 120.

In another embodiment, the controller 400 may be able to assist the clutch 200 with disengaging the previously selected ring gear. In certain operating conditions, the gearing of the multispeed transmission 120 may be lightly loaded, for example, if the vehicle is traveling at a constant speed on a flat road. For these operating conditions, the clutch 200 may easily disengage from the previously selected ring gear to effectuate a shift of the multispeed transmission 120. The controller 400 may evaluate the operating condition of the vehicle and command the clutch 200 to disengage the previously selected ring gear, while the inertia of the vehicle carries the vehicle forward. For operating conditions where the gearing of the multispeed transmission 120 is highly loaded (e.g., during a maximum vehicle acceleration or deceleration), the clutch 200 may not have sufficient force to overcome the loading condition of the gearing. For these operating conditions, the controller 400 may make a brief change in the rotational velocity of the electric motor 110. This change in the rotational velocity of the electric motor 110 may assist in using the inertia of the vehicle to at least partially unload the gearing as inertia carries the vehicle forward.

In one embodiment, the controller 400 may be configured to order upshifts and downshifts of the multispeed transmission 120 based on a given vehicle velocity. The controller 400 may operate the powertrain system 100 such that the electric motor 110 spends a maximum amount of time at its most efficient operating conditions. In another embodiment, the controller 400 may be configured to order upshifts and downshifts of the multispeed transmission 120 based on known driving conditions to avoid shifting speed modes at common vehicle velocities. For example, the controller 400 may be configured to order upshifts and downshifts at vehicle velocities slightly less than highway speeds to minimize upshifts and downshifts while the vehicle is operating at these velocities and to improve the responsiveness of the vehicle at these conditions.

In one embodiment, the controller 400 may be a stand-alone control unit that is dedicated to managing the operation of the multispeed transmission 120. In another embodiment, the controller 400 may be integrated into an engine control unit. In another embodiment, the controller 400 may be integrated into a body control module.

In one embodiment, the powertrain system 100 may include at least one speed sensor 402 that is used to calculate the rotational velocity of each ring gear. In one embodiment, the powertrain system 100 may include a speed sensor that determines the rotational velocities of the sun gear 130 and the carrier 160. A speed sensor 402 measuring the rotational velocity of the sun gear 130 may measure the rotational velocity of the electric motor 110, which is coupled with the sun gear 130. A speed sensor 402 measuring the rotational velocity of the carrier 160 may measure the rotational velocity of the differential 170 or the output shaft 180, both of which are coupled with the carrier 160. By measuring the rotational velocities of these components, the rotational velocities of the high-speed ring gear 150 and the low-speed ring gear 152 can be calculated.

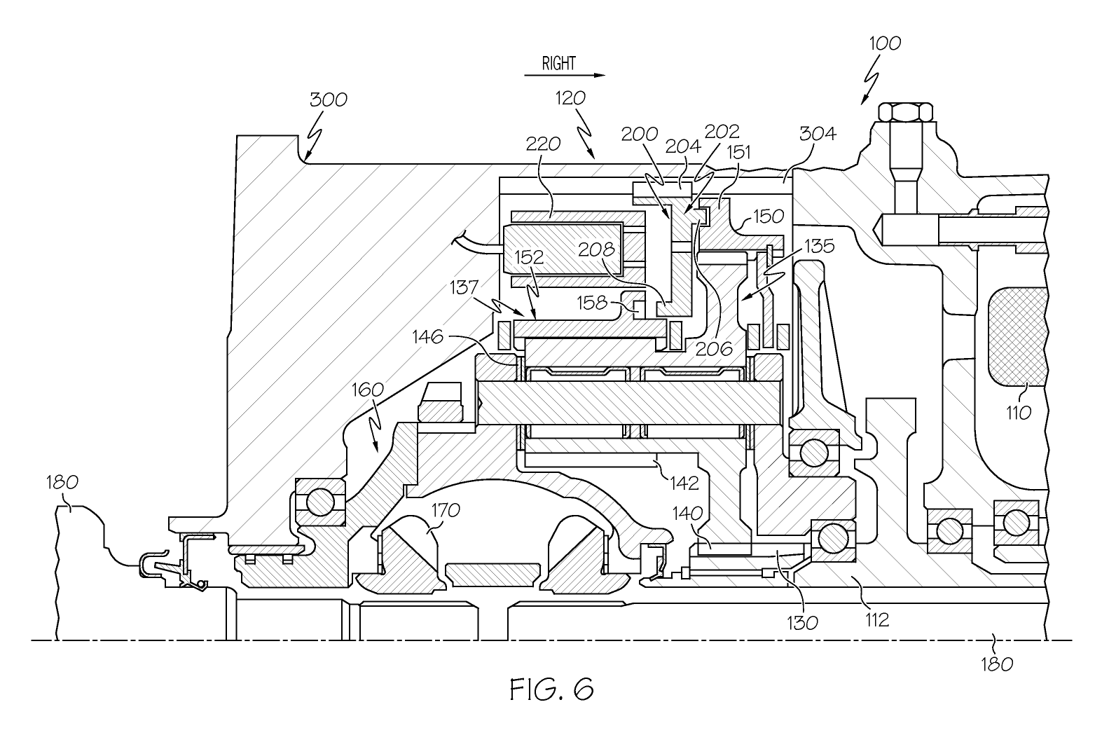

Referring to the embodiment of the powertrain system 100 schematically depicted in FIG. 6, the powertrain system 100 includes an electric motor 110 coupled with the transmission case 300. The electric motor 110 is coupled with an output shaft 112 that is itself coupled with a multispeed transmission 120 through a sun gear 130. The gearing on the sun gear 130 is meshed with the gearing on a high-speed planetary gear 140 of a high-speed gear set 135, which is coupled with a low-speed planetary gear 142 of a low-speed gear set 137. The high-speed planetary gear 140 and the low-speed planetary gear 142 are in constant mesh with the high-speed ring gear 150 and the low-speed ring gear 152, respectively. The high-speed and low-speed planetary gears 140, 142 are mounted on a carrier 160, and placed over a bearing 146, such as a journal bearing, to allow rotation of the high-speed and low-speed planetary gears 140, 142 on the carrier 160. The carrier 160 is coupled with a differential 170, that provides torque to at least one output shaft 180.

The clutch 200 may couple the high-speed or low-speed ring gears 150, 152 with the transmission case 300, which engages the various speed modes of the multispeed transmission 120. The clutch 200 illustrated in FIG. 6 uses a electromagnetic actuator 220 to change the axial position of an armature 202. The exterior splines 204 on the armature 202 are engaged with a series of interior splines 304 in the transmission case 300. The mating exterior and interior splines 204, 304 allow the armature 202 to translate axially, but prevent the armature 202 from rotating. In another embodiment, the armature 202 may be constrained from rotating within the transmission case 300 by at least one key placed in a keyway. When the armature 202 is in a right position (as illustrated in FIG. 6), right-side spline features 206 on the armature 202 engage spline features 151 on the high-speed ring gear 150. Because the armature 202 is prevented from rotating by the interior splines 304 in the transmission case 300, the high-speed ring gear 150 is prevented from rotating as well. With the armature 202 in this position, the high-speed gear set 135 controls carrier 160 rotation and the multispeed transmission 120 operates in a high-speed mode. In this operating mode, torque from the electric motor 110 is applied to the sun gear 130, which causes the high-speed planetary gear 140 to rotate and orbit. This orbiting movement causes the carrier 160 to rotate which, in turn, causes the differential 170 to rotate, and causes a torque to be applied to the output shaft 180.

When the armature 202 is in a left position (not shown), left-side spline features 208 on the armature 202 engage with spline features 158 on the low-speed ring gear 152. With the armature 202 in this position, the low-speed gear set 137 controls carrier 160 rotation and the multispeed transmission 120 operates in a low-speed mode. In this operating mode, torque from the electric motor 110 is applied to the sun gear 130, which causes the high-speed planetary gear 140 to rotate. The low-speed planetary gear 142 rotates at the same velocity as the high-speed planetary gear 140. Because the low-speed ring gear 152 is coupled with the transmission case 300, the low-speed planetary gear 142 orbits the sun gear 130. This orbiting movement causes the carrier 160 to rotate which, in turn, causes the differential 170 to rotate, and causes a torque to be applied to the output shaft 180.

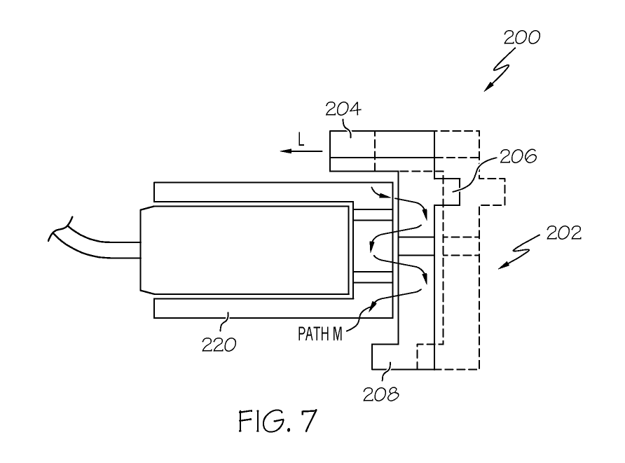

As depicted in FIG. 7, the electromagnetic actuator 220 shifts the armature 202 in a direction towards the left. While the electromagnetic actuator 220 is energized, the electromagnetic actuator 220 applies an attraction force to the armature 202, pulling the armature 202 to the left in the direction of arrow “L.” The electromagnetic actuator 220 creates a magnetic flux path, shown by “Path M.” A return spring shifts the armature 202 to the right when the electromagnetic actuator 220 is not energized.

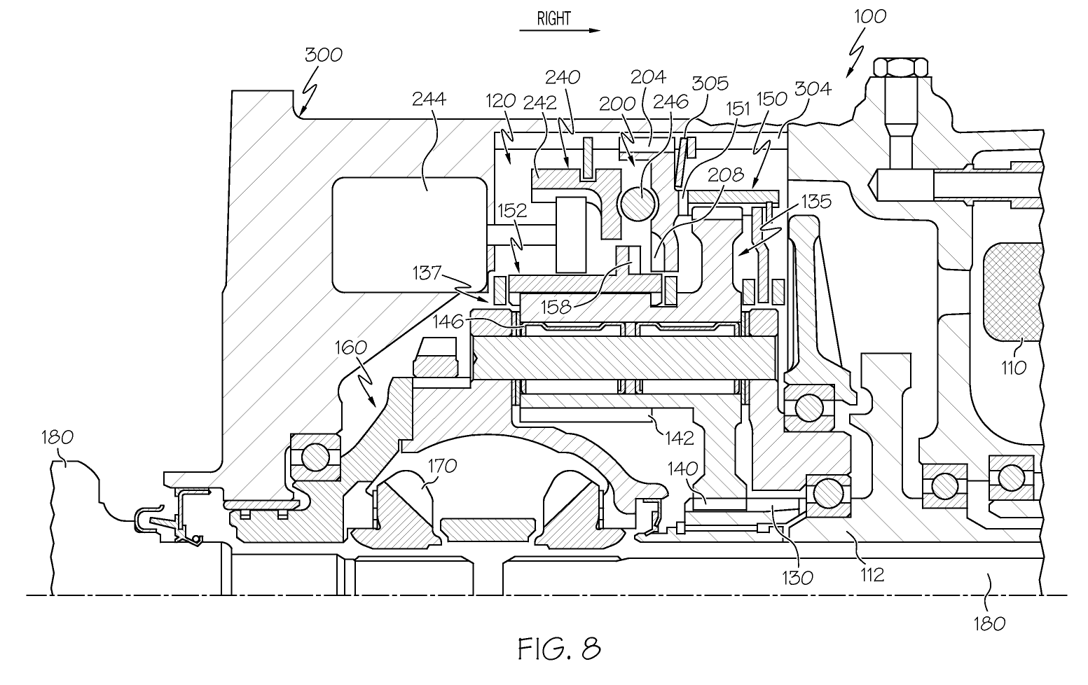

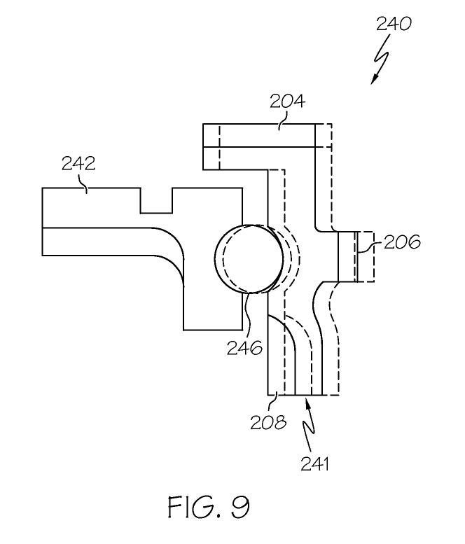

Referring to the embodiment of the powertrain system 100 schematically depicted in FIGS. 8 and 9, the multispeed transmission 120 may use a ball-ramp coupling 240 as the clutch 200. The ball-ramp coupling 240 uses a rotary actuator 244 to change the rotational orientation of a driving ramp plate 242. The driving ramp plate 242 may have a plurality of windows having a partially-helical shape. A plurality of balls 246 are inserted into these windows and contact the selector plate 241. The exterior splines 204 on the selector plate 241 mesh with interior splines 304 on the transmission case 300. The mating exterior and interior splines 204, 304 allow the selector plate 241 to translate axially, but constrain the selector plate 241 from rotating. As the rotary actuator 244 rotates the driving ramp plate 242 in one direction, the balls 246 change position in the driving ramp plate 242, moving shallower in the helical windows. When the balls 246 are positioned shallow in the helical windows of the driving ramp plate 242, the selector plate 241 is in a right position. In this position, the right-side spline features 206 on the selector plate 241 may engage the spline feature 151 on the high-speed ring gear 150. In this orientation, the selector plate 241 causes the multispeed transmission 120 to operate in a high-speed mode such that the high-speed gear set 135 controls carrier 160 rotation.

As the rotary actuator 244 rotates the driving ramp plate 242 in the opposite direction, the balls 246 move to a deeper portion in the helical windows. When the balls 246 are positioned deep in the helical windows of the driving ramp plate 242, a return spring 305 slides the selector plate 241 towards the left, such that the selector plate 241 is in a left position. In this position, the left-side spline features 208 on the selector plate 241 may engage the spline feature 158 on the low-speed ring gear 152. In this orientation, the selector plate 241 causes the multispeed transmission 120 to operate in a low-speed mode such that the low-speed gear set 137 controls carrier 160 rotation.

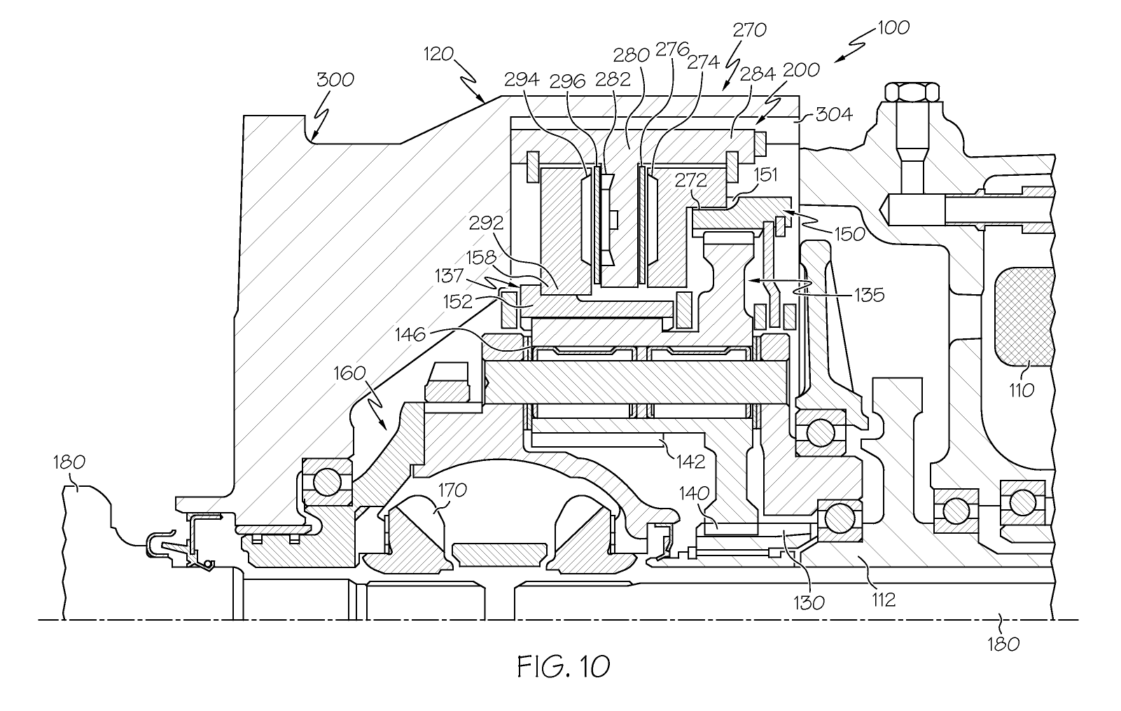

Referring to the embodiment of the powertrain system 100 schematically depicted in FIG. 10, the multispeed transmission 120 may use a SOWC 270 as the clutch 200. A one-way clutch can be thought of as a mechanical diode that allows adjacent parts to travel in only one direction relative to one another. A SOWC is a one-way clutch that can be controlled such that travel between adjacent parts can be allowed or prohibited. For the powertrain system 100 as described herein, an example of a SOWC is a Controllable Mechanical Diode available from Means Industries in Saginaw, Mich. A SOWC may use a series of selector locks that extend from a pocket plate and couple with a notch plate to prevent rotation of the notch plate. Movement of the selector locks are controlled by a selector plate. The selector plate may have a series of windows that control whether the selector locks may extend, and therefore couple the pocket plate with the notch plate. When the selector locks are retracted, the notch plate is free to rotate.

As depicted in FIG. 10, the SOWC 270 includes a pocket plate 280, a high-speed selector plate 276, a high-speed notch plate 274, a low-speed selector plate 296, and a low-speed notch plate 294. The high-speed notch plate 274 has a series of splines 272 that are meshed with spline features 151 on the high-speed ring gear 150 of the high-speed gear set 135. The low-speed notch plate 294 has a series of splines 292 that are meshed with spline features 158 on the low-speed ring gear 152 of the low-speed gear set 137. A plurality of selector locks may extend from a recess 282 in the pocket plate 280. The pocket plate 280 has a series of exterior splines 284 that mate with a series of interior splines 304 on the transmission case 300. The mating exterior and interior splines 284, 304 prevent the pocket plate 280 from rotating.

When operating the multispeed transmission 120 depicted in FIG. 10 in a low-speed mode such that the low-speed gear set 137 controls carrier 160 rotation, the low-speed selector plate 296 may be in an “open” position such that the selector locks can pass from the recess 282 in the pocket plate 280 to the low-speed notch plate 292. The high-speed selector plate 276 may be in a “closed” position such that the selector locks cannot pass from the pocket plate 280 to the high-speed notch plate 274. The high-speed notch plate 274 and the high-speed ring gear 150 are therefore free to rotate.

When an upshift of the multispeed transmission 120 is ordered, the low-speed selector plate 296 rotates to a “closed” position, forcing the selector locks to disengage from the low-speed notch plate 292. The electric motor 110 then reduces its rotational velocity so that the high-speed ring gear 150 of the high-speed gear set 135 and the high-speed notch plate 274 approach zero velocity. As the high-speed ring gear 150 and the high-speed notch plate 274 approach zero velocity, the high-speed selector plate 276 rotates to an “open” position, allowing a plurality of selector locks to extend, thus coupling the pocket plate 280 and the high-speed notch plate 274, and preventing the high-speed notch plate 274 and the high-speed ring gear 150 from rotating. The multispeed transmission 120 would then be operating in a high-speed mode such that the high-speed gear set 135 controls carrier 160 rotation.

In one embodiment, the SOWC 270 may be actuated by a servomechanism. In another embodiment, the SOWC 270 may be actuated by a electromagnetic actuator. In yet another embodiment, the SOWC 270 may be actuated by a hydraulic actuator.

The use of SOWCs 270 may allow the powertrain system 100 to be operated in a plurality of speed modes through the addition of corresponding planetary gears, ring gears, and SOWC components.

It should now be understood that hydraulic free multispeed transmissions for electric vehicles and fuel cell hybrid vehicles may include a clutch for selectively engaging one of a high-speed gear set or a low-speed gear set with a transmission case. With the multispeed transmission operating in a neutral state, the rotational velocity of the electric motor can be increased or decreased such that the rotational velocity of the ring gear of the newly-selected gear set approaches zero. By reducing the rotational velocity of the ring gear, a smooth gear shift may be accomplished using a clutch and without using a clutch that uses friction members. The vehicle powertrain system may include a controller that can speed or slow the rotational velocity of the electric motor to slow the rotational velocity of the appropriate ring gear.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A multispeed transmission comprising:
a sun gear;
a high-speed planetary gear in constant mesh with the sun gear and a high-speed ring gear, wherein the high-speed planetary gear orbits around the sun gear;
a low-speed planetary gear coupled with the high-speed planetary gear and in constant mesh with a low-speed ring gear;
a carrier rotationally engaged with the high-speed planetary gear and the low-speed planetary gear such that either the high-speed planetary gear or the low-speed planetary gear controls rotation of the carrier;
a transmission case that surrounds the high-speed ring gear and the low-speed ring gear; and
a clutch located proximate to the high-speed ring gear and the low-speed ring gear, wherein the clutch selectively couples the high-speed ring gear or the low-speed ring gear with the transmission case.

2. The multispeed transmission of claim 1, further comprising a differential gear set and at least one output shaft, wherein the carrier is coupled with the differential gear set and the differential gear set is coupled with the at least one output shaft.

3. The multispeed transmission of claim 1, further comprising an output shaft, wherein the carrier is coupled with the at least one output shaft.

4. The multispeed transmission of claim 1, further comprising a controller, and a first speed sensor and a second speed sensor that are electronically connected with the controller, wherein the controller determines the rotational velocities of the high-speed ring gear and the low-speed ring gear based on a measurement of the first speed sensor and the second speed sensor.

5. The multispeed transmission of claim 1, wherein the multispeed transmission operates in a low-speed mode when the clutch couples the low-speed ring gear with the transmission case and the multispeed transmission operates in a high-speed mode when the clutch couples the high-speed ring gear with the transmission case.

6. The multispeed transmission of claim 5, wherein when changing from the low-speed mode to the high-speed mode, the clutch disengages the low-speed ring gear placing the multispeed transmission in a neutral state, the rotational velocity of the high-speed ring gear is slowed such that it approaches zero, and the clutch engages the high-speed ring gear, and when changing from the high-speed mode to the low-speed mode, the clutch disengages the high-speed ring gear placing the multispeed transmission in the neutral state, the rotational velocity of the low-speed ring gear is slowed such that it approaches zero, and the clutch engages the low-speed ring gear.

7. The multispeed transmission of claim 1, wherein the clutch couples the high-speed ring gear and the low-speed ring gear with the transmission case by interference.

8. The multispeed transmission of claim 7, wherein the clutch comprises one of an armature and an electromagnetic actuator, a ball-ramp coupling, or a selectable one way clutch.

9. A powertrain system for an electrically-powered vehicle comprising:
an electric motor;
a multispeed transmission, the multispeed transmission comprising:
a transmission case connected to the electric motor;
a sun gear located in the transmission case and coupled with the electric motor;
a high-speed gear set in constant mesh with the sun gear;
a low-speed gear set connected to the high-speed gear set; and
a clutch arranged and configured to selectively change operating modes of the multispeed transmission from one operating mode to a different operating mode comprising a high-speed mode, a low-speed mode and a neutral state, the clutch engages the low-speed gear set with the transmission case to place the multispeed transmission in the low-speed mode.

10. The powertrain system of claim 9, wherein the clutch engages the high-speed gear set with the transmission case to place the multispeed transmission in the high-speed mode.

11. The powertrain system of claim 10, wherein the clutch disengages both the high-speed gear set and the low-speed gear set from the transmission case to place the multispeed transmission in the neutral state.

12. The powertrain system of claim 11, wherein the high-speed gear set comprises:
a high-speed planetary gear in constant mesh with the sun gear; and
a high-speed ring gear in constant mesh with the high-speed planetary gear, and the low-speed gear set comprises:
a low-speed planetary gear coupled with the high-speed planetary gear; and
a low-speed ring gear in constant mesh with the low-speed planetary gear.

13. The powertrain system of claim 12, wherein a rotational velocity of the electric motor controls a rotational velocity of the high-speed ring gear and a rotational velocity of the low-speed ring gear while the multispeed transmission is in the neutral state.

14. The powertrain system of claim 13, wherein when the multispeed transmission is selected to change to the high-speed mode, the rotational velocity of the high-speed ring gear approaches zero before the clutch engages the high-speed gear set, and when the multispeed transmission is selected to change to the low-speed mode, the rotational velocity of the low-speed ring gear approaches zero before the clutch engages the low-speed gear set.

15. The powertrain system of claim 14, wherein when the multispeed transmission is selected to change from the low-speed mode to the high-speed mode, the rotational velocity of the electric motor is decreased while the multispeed transmission is in the neutral state, and when the multispeed transmission is selected to change from the high-speed mode to the low-speed mode, the rotational velocity of the electric motor is increased while the multispeed transmission is in the neutral state.

16. A powertrain system for an electrically-powered vehicle having a multispeed transmission comprising:
an electric motor;
a transmission case coupled with the electric motor;
a sun gear located in the transmission case and coupled with the electric motor;
a high-speed gear set in constant mesh with the sun gear;
a low-speed gear set connected to the high-speed gear set; and
a clutch arranged and configured to selectively engage the high-speed gear set and the low-speed gear set with the transmission case for changing control of a carrier operatively connected to an output shaft of the vehicle.

17. The powertrain system of claim 16, wherein the high-speed gear set comprises:
a high-speed planetary gear in constant mesh with the sun gear; and
a high-speed ring gear in constant mesh with the high-speed planetary gear, and wherein the low-speed gear set comprises:
a low-speed planetary gear coupled to the high-speed planetary gear; and
a low-speed ring gear in constant mesh with the low-speed planetary gear.

18. The powertrain system of claim 17, further comprising a controller that controls operation of the electric motor and the clutch, the controller including logic that
commands the clutch to disengage the low-speed ring gear from the transmission case as to place the multispeed transmission in a neutral state,
commands the electric motor to change rotational velocity such that the rotational velocity of the high-speed ring gear approaches zero,
determines if a rotational velocity of the high-speed ring gear approaches zero, and
commands the clutch to engage the high-speed ring gear with the transmission case as to place the multispeed transmission in a high-speed mode.

19. The powertrain system of claim 18, wherein the controller includes further logic that
commands the clutch to disengage the high-speed ring gear from the transmission case as to place the multispeed transmission in the neutral state,
commands the electric motor to change rotational velocity such that the rotational velocity of the low-speed ring gear approaches zero,
determines if a rotational velocity of the low-speed ring gear approaches zero, and
commands the clutch to engage the low-speed ring gear with the transmission case as to operate the multispeed transmission in a low-speed mode.

20. The powertrain system of claim 19, further comprising at least two speed sensors, wherein the speed sensors each send an electronic signal to the controller, the controller interprets the electronic signals to determine the rotational velocity of the low-speed ring gear and the high-speed ring gear.
